(19) United States
(12) Patent Application Publication
(10) Pub. No.: US 2025/0263246 A1
(43) Pub. Date: Aug. 21, 2025

(54) DEVICE FOR HANDLING A PIECE OF GOODS AND METHOD FOR HANDLING A PIECE OF GOODS

(71) Applicant: Körber Supply Chain Logistics GmbH, Konstanz (DE)

(72) Inventors: Erik Hempel, Konstanz (DE); Raphael Enz, Steckborn (CH)

(21) Appl. No.: 19/055,228

(22) Filed: Feb. 17, 2025

(30) Foreign Application Priority Data
Feb. 15, 2024 (DE) 10 2024 104 189.7

(51) Int. Cl. B65G 43/00

(52) U.S. Cl. CPC B65G 43/00; B65G 2203/042

(57) ABSTRACT

A device for handling a piece good includes a support surface which is configured such that at least one piece good can rest on the support surface, a handling device configured to handle a piece good resting on the support surface such that the piece good is removed from the support surface, and a feed conveyor device configured to feed at least one piece good to the support surface, wherein the feed conveyor device includes a cascade conveyor. A handling system for handling piece goods and a method for handling a piece good are also provided.

### BACKGROUND OF THE INVENTION

The present invention relates to a device for handling a piece good, a handling system for handling piece goods and a method for handling a piece good.

In the prior art, it is common practice to estimate the mass of a piece good that is being handled for the first time, for example. Especially with a high throughput rate of piece goods, it is difficult to determine the exact mass of each individual piece good. As a result, handling of the piece goods can be inefficient or even fail. For example, the dimensions of a piece good are used to determine the mass of the piece good. However, this often provides incorrect results, as very small piece goods can have a very high mass or vice versa. When handling the piece goods, an incorrect mass of the piece goods is then assumed, which in turn results in incorrect handling.

It is therefore an object of the present invention to improve the handling of a piece good.

### SUMMARY OF THE INVENTION

According to one aspect of the present invention, a device for handling a piece good. The device may comprise a support surface designed to allow at least one piece good to rest thereon. The device may comprise a handling device designed to handle a piece good resting on the support surface such that the piece good is removed from the support surface. The device can comprise a feed conveyor device which is designed to feed at least one piece good to the support surface. The feed conveyor device can be designed as a cascade conveyor. Preferably, the feed conveyor device is designed as a cascade conveyor. The cascade conveyor can have at least two different levels, on each of which a conveyor element is provided. Each conveyor element can be designed to convey piece goods. The different levels can ensure that no piece goods rest on top of each other. This means that a 2D flow can be conveyed to the support surface. Furthermore, piece goods can be separated by the cascade conveyor in such a way that they are no longer adjacent to each other, even in a 2D stream. This can simplify subsequent handling of the piece goods. The support surface can be a surface that is designed for a piece good to lie on. The support surface can be the surface of a handle, for example. Furthermore, the support surface can also be the surface of a transport device on which the piece goods can rest. The support surface can be a support surface on which the at least one piece good comes into contact with the support surface. The piece good can be a postal item such as a parcel, package, transport roll, transport bag, small, cardboard box or similar. Preferably, the support surface is designed so that a large number of piece goods can rest on it. Preferably, the large number of piece goods can rest on the support surface in an unordered manner. The handling device can be designed to handle a piece good in order to move it to another location. In other words, the handling device can be designed to physically move the piece good (e.g. the target piece good). To this end, the handling device can pick up, grip and/or suck the piece goods in order to handle them. Furthermore, the handling device can also pull or push the piece goods in order to handle them. In particular, the handling device can be designed to remove the piece goods from the support surface. In other words, the handling device can change a first state, in which the piece good rests on the support surface, to a second state, in which the target piece good no longer rests on the support surface. This allows the handling device to remove the target piece good from the support surface.

The at least two levels can be connected to each other by an inclined and chute-like connection. This allows a cascade conveyor to act as a kind of buffer system. Furthermore, a 3D flow can be safely resolved and converted into a 2D flow. The chute-like connection can be a passive element that does not have a conveyor mechanism or the like. The connections can be arranged at an angle relative to the horizontal. By driving the conveyor element on the respective level of the cascade conveyor, piece goods can be conveyed further in the transport direction so that they slide down the connection to the next level. The conveyor elements can be arranged parallel to the horizontal. This means that piece goods that slide down onto the conveyor element from an upstream connection can be stopped and only transported further by actively driving the conveyor element. The cascade conveyor can be connected directly or indirectly to the support surface. Furthermore, the cascade conveyor can have guide walls on the side (i.e. parallel to the conveying direction), so that piece goods are prevented from falling off the side of the cascade conveyor. This allows piece goods to be fed to the cascade conveyor in a 3D stream, for example as 3D bulk. Even when feeding a large number of piece goods, the cascade conveyor can be designed to generate at least a 2D flow. In other words, by alternately conveying the piece goods with the conveyor element and sliding the piece goods on the connection, it can ensure that no piece good rests on another.

Preferably, at least one of the conveyor elements is designed to be driven intermittently. In other words, at least one of the conveyor elements can only be in operation for two periods and convey piece goods. This can further increase the buffer effect. In other words, a large number of piece goods can rest on the cascade conveyor. By briefly activating at least one conveyor element, individual piece goods can be conveyed and separated from the other piece goods by the next downstream connection. Furthermore, at least two conveyor elements can be operated at different times. In other words, it can be avoided that two conveyor elements are operated simultaneously. This can ensure that piece goods are better separated from each other.

Preferably, the device has a feed conveyor device which is designed to feed at least one piece good to the support surface. In other words, a feed conveyor device can be arranged upstream of the support surface, which can feed piece goods to the support surface. The feed conveyor device (cascade conveyor) can be designed to buffer piece goods while a measurement is being carried out on the support surface. In other words, the device can be arranged in a continuous package flow and the feed conveyor device can still ensure that piece goods are fed individually to the support surface. The feed conveyor device can, for example, comprise a conveyor belt, roller conveyor, belt conveyor or the like.

Preferably, the feed conveyor device can be designed to generate a 2D flow or a 1D flow. In other words, the feed conveyor device can provide a reduction in the spatial dimensions of the piece goods. In a 3D flow, piece goods are arranged in three-dimensional storage. In a 2D stream, a storage of piece goods is reduced to a single plane, often in an ordered sequence for further processing, e.g. for scanning, sorting or loading into vehicles. Thus, the feed conveyor device can be designed to destack a 3D stream and realize a uniform process height for the piece goods. In summary, the feed conveyor device can provide a conversion of a 3D stream into a 2D stream by reducing the height dimension of the 3D stream. A 1D flow is present when piece goods are only conveyed one behind the other (i.e. not next to each other). This can occur when piece goods fall in a certain way or when fewer piece goods are conveyed.

Preferably, the device comprises a measuring device which is designed to detect a mass of at least a part of the support surface on which the at least one piece good rests and to output a mass measurement value, and a control unit which is designed to determining the mass of the piece good based on a first mass measurement value and/or a second mass measurement value, wherein the first mass measurement value comprises the mass of at least a part of the support surface and the piece good, and wherein the second mass measurement value comprises the mass of at least a part of the support surface without the mass of the piece good.

Compared to the known prior art, the device according to one aspect of the present invention provides the advantage that a mass of a piece good can be determined without calibration of the device. As a result, the device for determining a mass of the target piece good (i.e. a piece good from the plurality of piece goods) can be implemented particularly easily. Furthermore, the device can feed the mass of the target piece good to a downstream device or system. This can improve downstream handling of the piece good. In other words, downstream handling can be individually adapted to the mass of the target piece good. Furthermore, the handling device can be controlled based on the specific mass of the target piece good. For example, the handling dynamics can be reduced for particularly heavy piece goods, thus reducing the risk of losing or damaging the target piece good during handling. For particularly light piece goods, on the other hand, the dynamics can be increased, which in turn increases the throughput of the device. In the prior art, it is only known to control the handling device based on the geometric dimensions of the piece goods. It is assumed that the weight or mass of the piece good correlates with its size. However, this is rarely correct. For example, there may be piece goods with small geometric dimensions that have a particularly high weight. The device is therefore also suitable for an inhomogeneous range of piece goods and can handle piece goods of this type without any problems.

The device for determining a mass can be a device that is part of a handling system for piece goods. For example, the device can be used in a sorting center for piece goods, in particular mail items. The mass can denote the weight of a piece good. The target piece good can be the piece good to be handled by the handling device. In other words, a large number of piece goods may be present, of which exactly one is to be handled next by the handling device. This one piece good can be referred to as the target piece good. The measuring device can be designed to detect a mass of at least part of the support surface, regardless of how many piece goods are resting on the support surface. Thus, the measuring device can detect a mass of at least part of the support surface if, for example, 20 piece goods are resting on it. In other words, the measuring device can output a measured mass value that is indicative of the mass of at least part of the support surface and the piece goods resting on it. It is not necessary for the measuring device to be able to measure the mass of the entire support surface. Rather, the measuring device can only determine the mass of a part of the support surface. For example, the part of the support surface whose mass can be determined by the measuring device can be the part of the support surface on which piece goods can come to rest. In other words, it is not absolutely necessary to weigh a frame or other parts of the support surface on which no piece good can come to rest. The measuring device can then be designed to output a measured mass value. The measured mass value can be one of the output information, which is indicative of a detected mass. The control unit can be a computer-like device that is designed to receive information (input information), process the information and output information (output information). The input information supplied to the control unit may include the mass measurement value determined by the measuring device. The control unit can receive a variety of mass measurement values. The output information provided by the control unit can be control commands to control a device or element. For example, the control unit can receive a first mass measurement value and a second mass measurement value, each of which can be determined by the measuring device. The first mass measurement value and the second mass measurement value can differ in that they have been measured by the measuring device at different times. For example, the first mass measurement value can be measured when the target piece good is resting on the support surface. In contrast, the second measured mass value can be measured when the handling device has removed the target piece good from the support surface. In this case, measurement can be equated with detection. The first mass measurement value and the second mass measurement value can include a number of other masses, for example other piece goods. The first mass measurement value can differ from the second mass measurement value. Preferably, only the presence of the target piece goods changes between the first mass measurement value and the second mass measurement value. Based on the first mass measurement value and the second mass measurement value, the control unit can then determine the mass of the target piece good. More precisely, the control unit can be designed to subtract the second mass measurement value, i.e. the mass measurement value that is detected later, from the first mass measurement value. This difference can be used to determine the mass of the target piece good. This means that it is not necessary to calibrate the measuring device, as only the difference between the first mass measurement value and the second mass measurement value is used to determine the mass of the target piece good. As a result, the determination of the mass can be robust and the device can be easily integrated into existing systems. By knowing the exact mass of the target piece good, the handling of the target piece good by the handling device can be adjusted. Furthermore, by knowing the mass of the target piece good, downstream systems can handle the target piece good individually. This can improve the overall efficiency and reliability of a higher-level handling system. The target piece good can also comprise two or more piece goods that are gripped together, for example.

The mass of the target piece good can also be determined by a single measured value, for example if only one piece good, namely the target piece good, rests on the support surface. This allows a mass measurement value to be determined that comprises the mass of the target piece good (i.e. as the only piece good resting on the support surface) and the support surface or at least part of the support surface. In this case, the mass of the support surface or at least part of the support surface must be known. In this way, the mass of the target piece good can be inferred. Additionally or alternatively, the second mass measurement value can also be indicative of a mass of the support surface or at least part of the support surface. The information as to whether the target piece good is the only piece good resting on the support surface can be obtained, for example, from a sensor device or a measuring device. The sensor device can be a camera system, for example, which can detect the support surface. Preferably, the sensor device is the same sensor device that is used to control the handling device. This allows the mass of the target piece good to be determined in a way that is adapted to the situation and increases efficiency. In other words, the mass of the target piece good can be determined particularly quickly if only the target piece good rests on the support surface.

Preferably, the support surface is a transport device that is designed to transport the at least one piece good in a transport direction. The support surface can therefore be a surface of a transport device. The transport device can be a conveyor belt, roller conveyor, belt conveyor or the like, which is designed to transport the piece good. The transport direction can run from an upstream side of the transport device to a downstream side of the transport device. This means that the device can also be arranged on existing transport devices and can also determine the mass of a target piece good there.

Preferably, the transport device is designed to be driven periodically. The transport device can have a section that can be analyzed by the measuring device. In other words, the transport device can have a section that is weighed by the measuring device with all the piece goods that are on it at the time of measurement. In order not to feed any new piece goods onto the measured area of the transport device between the recording of the first mass measurement value and the second mass measurement value, the transport device can be driven periodically or stepwise. In other words, the transport device cannot be driven between the measurement times at which the first mass measurement value and the second mass measurement value are recorded. This can ensure that no further piece goods are transported to the area of the transport device that is being measured or weighed by the measuring device. This can improve the quality of the results. Furthermore, incorrect measurements can be avoided. For example, the feed conveyor device can be operated as a function of the measuring device. More precisely, the feed conveyor can be driven when no measurement is being carried out. As soon as a measurement is carried out, the feed conveyor device can stop for a short time to prevent further piece goods from being fed to the support surface. This ensures that piece goods are applied to the support surface during a measurement process.

Preferably, the control unit is designed to control the handling device based on the mass of the target piece good. In other words, the handling device can be controlled depending on the mass of the target piece good. By determining the mass of the target piece good as soon as the target piece good is lifted or removed from the support surface, information about the mass of the target piece good can be provided very quickly. Based on this, the handling speed of the handling device can be adjusted, for example. For example, the handling speed or the handling acceleration (i.e. the dynamics) can be reduced for particularly heavy piece goods in order to prevent the piece good from falling or being damaged. For particularly light piece goods, on the other hand, the handling speed and/or handling acceleration can be increased in order to increase the throughput of handled piece goods. This can increase the efficiency of the overall system.

Preferably, the control unit is designed to assign the mass of the target piece goods to the piece good information and preferably to store it. Each piece good that is handled in a higher-level handling device for handling piece goods has piece good information. The piece good information can be indicative of a destination of the piece good. For example, in the case of postal items, the address is included in the piece good information. The control unit can therefore assign the mass determined by the device to the piece good information. This means that the mass can be available for later handling in a subsequent process, and the handling can be carried out in a targeted and adapted manner. Preferably, the mass of the target piece good can also be permanently stored in the piece good information. Consequently, the control unit can be designed to communicate with a database in order to assign a mass to the respective piece goods. The device can also comprise a recognition system, which can be designed to identify the piece goods. Therefore, an existing data set (e.g. piece good information) can be assigned to a piece good and the specific mass, which is determined by the device, can also be assigned. Additionally or alternatively, the control unit can also obtain information about which piece good is being or has been handled by the handling device. This means that it is not necessary to identify the handled piece good in the device itself.

Preferably, the measuring device is a scale integrated into the support surface or on the support surface. In other words, the support surface can itself be a scale. It is also conceivable that a scale is arranged on the support surface so that at least a section of the support surface can be bent. It is conceivable here that the scale or load cell is in contact with the support surface in order to pick up a mass of the support surface or at least a part of the support surface and the piece goods located thereon.

Preferably, the measuring device is provided on a frame that supports the support surface. In this case, the measuring device can be designed as at least one load cell, which can be arranged on a frame. The frame can, for example, be a frame structure that supports the support surface. The measuring device can be arranged at connections of the frame between the substrate and the support surface. In other words, the measuring device may comprise a plurality of individual measuring sensors. The individual measuring sensors can each provide results, which are then combined to determine the mass of the support surface or at least part of the support surface with the piece goods on it. For example, the frame can be a frame with four feet, with a measuring sensor (e.g. a load cell and/or a strain gauge) of the measuring device arranged on each foot. The measuring device may, for example, comprise strain gauges arranged on the frame.

Preferably, the measuring device is designed to detect a mass of at least a part of the support surface based on an operating information of the device. In other words, the measuring device can perform a measurement when it receives a control signal. This allows a measurement to be initiated if it is ensured that no further piece goods are placed on the support surface and/or removed unintentionally between the first measurement and the second measurement. This control signal can also be generated automatically by the measuring device communicating with a drive or control unit that is responsible for determining whether or not piece goods are placed on the support surface. This can ensure that no further piece goods are placed on the support surface between the first measurement and the second measurement and thus falsify the measurement result. Furthermore, a measurement can also be triggered by the measuring device if, for example, a previous measurement has delivered an unrealistic result. This may be a system-related error or an error caused by external influences, for example, so that a new measurement can be carried out. In this way, an automated attempt can be made to correct an incorrect measurement without the need for manual intervention by a user.

Preferably, the operating information comprises a state of the at least one piece good on the support surface. In other words, the operating information can be indicative of how a piece good is resting on the support surface. Furthermore, the operating information can be indicative of how many piece goods are resting on the support surface. For example, the operating information can indicate whether a pile of piece goods is lying on the support surface. This makes it possible to determine whether the pile is unstable and whether individual or several piece goods could fall out of the pile. This allows the time at which a mass measurement is carried out to be varied. Errors due to movements in a pile of piece goods can thus be avoided.

Preferably, the operating information can be indicative of whether the at least one piece good is at rest or in motion. In other words, it can be used to determine whether piece goods are currently being applied to the support surface or whether the piece goods are at rest on the support surface. This prevents a mass measurement from being carried out in a state in which piece goods are being placed on the support surface. A mass measurement can only be carried out when the piece goods are at rest on the support surface. This prevents incorrect measurements from being carried out.

Preferably, the operating information comprises image information of the at least one piece good. In other words, the piece goods resting on the support surface can be recorded by an image sensor in order to determine whether the piece goods are at rest or in motion. For this purpose, at least two images of the at least one piece good can be recorded and compared with each other. If the two images are identical (i.e. the piece good is at the same position and/or in the same orientation in both images), it can be assumed that the piece good is at rest and is no longer moving. In such a case, the mass measurement can be triggered.

Preferably, the image information is obtained from a sensor system, in particular the handling device. The sensor system can be arranged above the support surface and create image data of the at least one piece good from vertically above the support surface. Preferably, an existing sensor system of the handling device can be used for this purpose. Such a sensor system can, for example, be implemented as a vision system. Such a system is usually necessary to control the handling device. By using the image information from an existing sensor system, the device can be implemented particularly easily, as no new sensors are required that would have to be installed separately. Instead, existing sensor information can be used to determine the condition of at least one piece good on the support surface.

Preferably, the operating information is generated by at least one light barrier. In other words, information from light barriers can additionally or alternatively be used to find out whether the piece goods are at rest or in motion on the support surface. For example, at least one light barrier can be provided upstream of the support surface, which can detect whether further piece goods are being conveyed to the support surface or not. In the same way, at least one light barrier can be provided in the area of the support surface to check whether or not further piece goods are being conveyed to the support surface.

Preferably, a blocking element can be provided upstream of the support surface, which is designed to block the feed path of piece goods to the support surface. In other words, the blocking element can be designed to prevent piece goods from being fed to the support surface. For this purpose, the blocking element can be moved back and forth between a release position and a blocking position. In the release position, mail items can be fed to the support surface unhindered. In the blocking position, the blocking element can prevent piece goods from being fed to the support surface. This can ensure that further piece goods are prevented from being fed to the support surface during a measuring process of the measuring device. In other words, the blocking element can be in the blocking position during a measuring process of the measuring device. As soon as the measuring process is over, the blocking element can be moved to the release position so that further piece goods can be fed to the support surface. This is a simple way of preventing piece goods from being unintentionally placed on the support surface during a measuring process.

Preferably, the feed conveyor device is designed as a conveyor belt. This allows piece goods to be conveyed to the support surface in a controlled manner. Furthermore, the conveyor belt can also be driven backwards, for example to convey piece goods away from the support surface. For example, a pile of piece goods can be separated and/or piece goods resting on the feed conveyor device and the support surface can be removed.

Preferably, the measuring device is designed to perform a measurement with an accuracy of at least plus/minus 100 g. In other words, it is not necessary to determine the exact weight of a piece good to the gram, but it is sufficient to determine the weight of a piece good in the 100 gram range. This accuracy has proven to be sufficient for the satisfactory handling of piece goods, particularly in the mail sector.

Preferably, the handling device is a robot, in particular a SCARA robot. The robot can, for example, be designed as a robot arm that is designed to pick and physically move piece goods. For example, the robot arm can approach a specific piece good (i.e. the target piece good), pick it up and place it in a desired position. A SCARA robot can have four axes and four degrees of freedom. All axes can be designed as serial kinematics. In other words, the coordinate origin of the following axis can be dependent on the position of the previous axis. In a SCARA robot, the first and second axes can be of a rotational nature, the third and fourth axes can be made from a single component (for example as a ball screw) and allow rotational and linear movements to be performed. A gripping element can be mounted on the handling device at the lower end in the Z-axis (i.e. in the direction of gravity).

Preferably, the feed conveyor device is designed to convey the piece goods at least partially in the direction of gravity. In other words, the feed conveyor device has a conveying surface, at least in sections, on which the piece goods are conveyed or move by the downhill force. This can form a passive part of the feed conveyor device in order to create a buffer effect for piece goods. This allows the piece goods to be separated in a targeted manner.

Preferably, the handling device is designed to deposit the target piece good on a target area at a distance from the support surface. The target area can, for example, be another conveyor belt, a sorter or an end point. This means that the device can be used in a wide range of applications.

Preferably, the control unit is designed to determine the target area for the target piece goods depending on the mass of the target piece goods. For example, the device can thus be used to sort out piece goods that are too heavy or too light from a stream of piece goods before a certain handling of the piece goods. If, for example, a piece good is too heavy or too light for subsequent handling, this piece good can be applied to a different target area, where the piece good is then subjected to special treatment. In this way, it can be avoided during subsequent handling of the piece good that piece goods cause problems or have to be manually ejected.

Preferably, the handling device is designed to handle the target piece good by means of negative pressure. In other words, the handling device can have a suction gripper that can grip and pick up the target piece good by means of a suction gripper. This means, for example, that the required vacuum can also be adapted to a specific mass of the target piece good. Particularly heavy piece goods may require a higher vacuum in order to be held securely on the handling device than comparatively lighter piece goods. This can further increase the efficiency of the operation of the handling device, as it prevents an unnecessarily high negative pressure from being provided.

Preferably, the target piece good is determined on the basis of piece good information of the at least one piece good. Preferably, a large number of piece goods can be placed on the support surface. It must therefore be decided which piece good is to be picked up next by the handling device. For example, the piece good closest to the handling device can be determined as the target piece good. Furthermore, a piece good can be determined as the target piece good, which has a suitable orientation to be handled by the handling device. The piece good to be handled can be designated as the target piece good. This target piece good can be defined on the basis of piece good information of the plurality of piece goods that are available on the support surface. For example, the piece good information may include location information, orientation, external physical characteristics or the like. In other words, a recognition system of the handling device can determine which piece good is to be gripped next. For example, if there is a pile of piece goods, the topmost piece good can be gripped first, as this prevents the pile from collapsing and piece goods from falling from the support surface to an area that can no longer be reached by the handling device.

According to a further aspect of the present invention, a handling system for handling piece goods is provided. The handling system may comprise the apparatus according to any of the above embodiments. The handling system may comprise a handling unit located downstream of the device for handling piece goods. The handling unit may be controlled based on the mass of the target piece good determined by the device. The handling unit located downstream of the device can, for example, be an injection (e.g. a high-speed injection), which is designed to inject piece goods onto a sorter or another conveyor device. The information about the mass of the piece goods to be injected can be important here, as it can be used to determine how the respective piece goods can be accelerated. This can ensure safe handling of the piece goods in a downstream process. Furthermore, the information about the mass of the piece good can be used to prevent a particularly heavy piece good from being placed on top of other piece goods, for example at an end point. This can prevent the other piece goods from being damaged. Such a particularly heavy piece good can, for example, be ejected or handled in such a way that it does not come into contact with other piece goods.

According to one aspect of the present disclosure, a method for handling a piece good is provided. The method comprises feeding a piece good on a feed conveyor configured as a cascade conveyor, wherein the piece goods are fed such that at least one 2D stream is generated from a 3D stream.

According to a further aspect of the present invention, a method for determining a mass of a target piece good is provided. The method comprises obtaining or detecting a first mass measurement value of a support surface on which at least one piece good rests, and/or obtaining or detecting a second mass measurement value of the support surface. Furthermore, the method comprises handling the target piece good so that the target piece good is removed from the support surface. Further, the method may comprise determining a mass of the target piece good based on the first mass measurement value and/or the second mass measurement value. Obtaining the first mass measurement value can be realized, for example, in such a way that the first mass measurement value is determined by an external device or is supplied from a database. The detection, on the other hand, can be realized by analyzing the support surface or at least a part of the support surface in order to determine its mass together with the at least one piece good on it. This means that the mass of the target piece good can also be determined using only a single mass measurement value if, for example, there is only a single target piece good on the support surface. This assumes that the weight of the support surface and any other elements connected to it are known. Additionally or alternatively, the mass of the support surface and any other elements connected to it can also be specified by the second measured mass value.

According to a further aspect of the present invention, there is provided a use of a device according to one of the above embodiments for handling piece goods.

Individual features and embodiments can be combined with other features or other embodiments to form new embodiments. Advantages and embodiments mentioned in connection with the individual features or the embodiments then apply analogously to the new embodiments. Advantages and embodiments mentioned in connection with the device also apply analogously to the method and vice versa.

### BRIEF DESCRIPTION OF THE DRAWINGS

In the following, the present invention is described in detail by means of embodiments with reference to the accompanying drawings.

FIG. 1 is a schematic and perspective view of a device for determining a mass of a target piece according to an embodiment of the present invention; and

FIG. 2 is a schematic flow chart of a method according to one embodiment of the present invention.

### DETAILED DESCRIPTION OF THE PREFERRED EMBODIMENTS

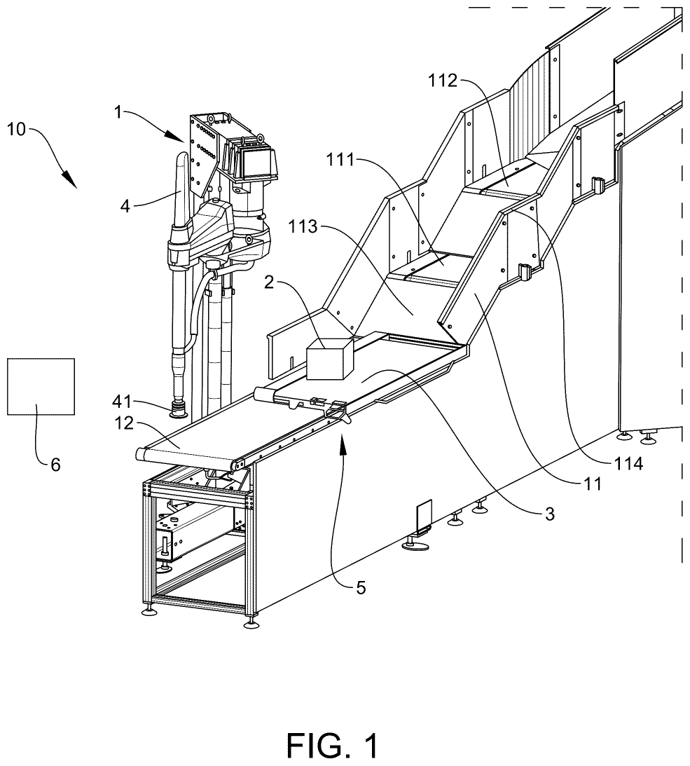

FIG. 1 shows a schematic perspective view of a device 1 for handling a piece good 2. More precisely, FIG. 1 shows a handling system 10, which comprises the device 1. The handling system is described below. The device 1 comprises a support surface 3, which can accommodate a plurality of piece goods 2. For the sake of simplicity, only one piece good 2 is shown in FIG. 1. In the present embodiment, the piece good 2 is a mail item that is to be sent for further processing (e.g. sorting). The device 1 has a handling device 4 in the form of a robot arm. The handling device has a functional end 41 with which a piece of mail 2 can be handled. In the present embodiment, the functional end 41 is a suction gripper that can suck in the piece goods by means of negative pressure. Thus, the handling device 4 can handle the piece good 2, which rests on the support surface 3, in such a way that it can be fed from the support surface 3 to a downstream conveying device 12, which is part of a higher-level handling device. In other words, the handling device 4 can remove the piece good 2 from the support surface 3 so that the piece good 2 no longer rests on the support surface 3. According to one aspect of the present invention, the device 1 may be part of a handling system 10. The handling system can also have a cascade conveyor 11 upstream of the device 1. Furthermore, the handling system 10 may have a conveyor 12 downstream of the device 10. The cascade conveyor 11 can have at least two different levels, on each of which a conveyor element 111 and 112 is arranged. Furthermore, the different levels can be connected with connecting chutes 113 and 114. By activating the conveyor elements 111 and 112, piece goods can be conveyed onwards piece by piece. In this way, the cascade conveyor 11 can function as a buffer to prevent piece goods from being continuously fed to the support surface 3 in a continuous flow of piece goods. This can simplify operation of the handling device 4, as each piece good can be gripped individually. Furthermore, the intermittent feeding of piece goods 2 to the support surface 3 can optionally ensure that no additional piece goods are fed to the support surface 3 while the first mass measurement value and the second mass measurement value are being recorded. The downstream conveyor 12 of the handling system 10 is designed as a conveyor belt and transports the piece goods handled by the handling device 4 onwards to other handling devices.

Furthermore, the device 1 of the present embodiment has a measuring device 5, which is designed to determine a mass of the support surface 3. In the present embodiment, the entire support surface 3 is connected to the base via the measuring device 5. Thus, as soon as a piece good 2 rests on the support surface 3, the measuring device 5 can determine the mass of the support surface 3 together with the piece goods 2 on it. Furthermore, in the present embodiment, the support surface 3 is designed as a conveyor belt. This means that the support surface is the contact surface between the piece good 2 and the conveyor belt. The measuring device 5 can output measured mass values. Preferably, the measuring device 5 is an integrated scale that is integrated into the conveyor belt that forms the support surface 3. Additionally or alternatively, the measuring device can also be provided on a frame of the conveyor belt. For example, the measuring device can comprise load cells that are provided at each foot of the conveyor belt. For example, two weighing devices can also be included in the measuring device so that redundant measurement is possible. This means that if one measuring system fails, a measurement result can still be obtained. During operation, the measuring device can record a measured mass value of the support surface 3 when the target piece good 2 is resting on it and record a second measured mass value when the target piece good 2 is gripped by the handling device 4 and removed from the support surface. Based on the difference, a control unit 6 of the device 1 can determine the difference between the two mass measurement values and thus deduce the mass of the target piece good 2. This allows the mass of the target piece good 2 to be determined. The movement of the handling device 4 can be adjusted based on the determined mass. Thus, the handling device 4 can be moved just fast enough so that the target piece good 2 does not fall off the functional end 41 of the handling device 4.

In the case where the support surface 3 is designed as a conveyor belt, the piece goods 2 located on the support surface 3 can be transported further in the transport direction during the measurement. This is possible and does not affect the mass determination as long as no other piece goods 2 hit the support surface 3.

In a further embodiment not shown, the handling system 10 comprises a separate conveyor upstream of the device 1 instead of the cascade conveyor, which can be driven intermittently. This can also ensure that piece goods are only fed to the support surface 3 intermittently. This ensures that no piece goods are applied to the support surface 3 while the mass measurement values are being recorded.

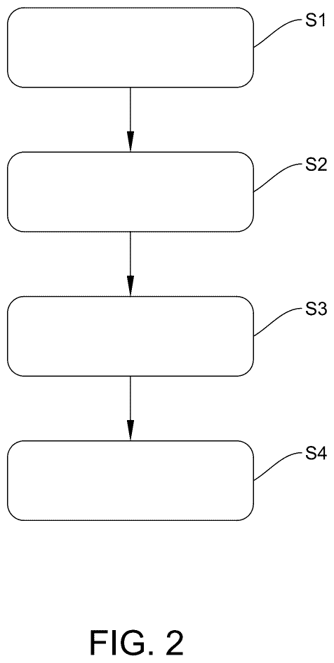

FIG. 2 is a schematic flow chart illustrating a method according to one embodiment of the present invention. In a first step S1, a first mass measurement value of the support surface 3, on which at least one piece good 2 rests, is obtained or detected. The first mass measurement value is obtained by transferring it from a database or from a previously determined measurement. On the other hand, the first measured mass value is detected when it is measured by the measuring device 5 itself. In step S2, the target piece good 2 is removed from the storage surface 3. To do this, the handling device 4 can pick up, push away or pull away the piece good so that the piece good 2 is no longer in contact with the support surface 3. The second measured mass value is then obtained or detected in step S3. Here too, the measured mass value can be obtained by a data line from previous processes or other devices or determined by the measuring device 5 itself. Subsequently, in step S4, the mass of the target piece good 2 is determined based on the measured mass values. More precisely, a difference is formed from the first mass measurement value and the second mass measurement value in order to determine the mass of the target piece good. This allows the mass of the target piece good to be determined without any problems.

### LIST OF REFERENCE SIGNS

1 Device
2 Target piece goods
3 Support surface
4 Handling device
5 Measuring device
6 Control unit
10 Handling system
11 Cascade conveyor
12 Conveyor belt
111 Conveyor element
112 Conveyor element
113 Slide element
114 Slide element

The invention claimed is:

1. A device for handling a piece good, comprising:
a support surface, configured such that at least one piece good can rest on the support device;
a handling device configured to handle a piece good resting on the support surface such that the piece good is removed from the support surface; and
a feed conveyor device configured to feed at least one piece good to the support surface;
wherein the feed conveyor device includes a cascade conveyor.

2. The device according to claim 1, wherein the feed conveyor device includes different levels on each of which a conveyor element is provided.

3. The device according to claim 2, wherein the different levels are connected to each other by an inclined and slide-like connection.

4. The device according to claim 3, wherein by driving the conveyor element on the respective level of the cascade conveyor, piece goods can be conveyed further in the transport direction so that the piece goods slide down the connection to the next level.

5. The device according to any one of claim 4, wherein at least one of the conveyor elements is configured to be driven intermittently.

6. The device according to claim 5, wherein the cascade conveyor has lateral guide walls so that piece goods are prevented from falling down laterally from the cascade conveyor.

7. The device according to claim 6, wherein the feed conveyor device is configured to buffer piece goods.

8. The device according to claim 7, wherein the feed conveyor device is configured to generate a 2D stream or a 1D stream.

9. The device according to claim 2, wherein by driving the conveyor element on the respective level of the cascade conveyor, piece goods can be conveyed further in the transport direction so that the piece goods slide down the connection to the next level.

10. The device according to any one of claim 2, wherein at least one of the conveyor elements is configured to be driven intermittently.

11. The device according to claim 2, wherein the cascade conveyor has lateral guide walls, so that piece goods are prevented from falling down laterally from the cascade conveyor.

12. The device according to claim 1, wherein the feed conveyor device is configured to buffer piece goods.

13. The device according to claim 1, wherein the feed conveyor device is configured to generate a 2D stream or a 1D stream.

14. The device according to claim 1, further comprising:
a measuring device which configured to detect a mass of at least a part of the support surface on which the at least one piece good rests and to output a mass measurement value; and
a control unit configured to determine the mass of the piece good based on a first mass measurement value and/or a second mass measurement value;
wherein the first mass measurement value comprises the mass of at least a part of the support surface and the piece good; and
wherein the second mass measurement value comprises the mass of at least a part of the support surface without the mass of the piece good.

15. The device according to claim 14, wherein the control unit is configured to control the handling device based on the mass of the piece good.

16. The device according to claim 14, wherein the measuring device is configured to detect a mass of at least a part of the support surface based on an operating information of the device.

17. The device according to claim 1, wherein the handling device includes a SCARA robot.

18. The device according to claim 1, wherein the feed conveyor device is configured to convey the piece goods at least partially in the gravity direction.

19. A handling system for handling piece goods, comprising:
the device according to claim 1; and
a handling unit located downstream of the device for handling piece goods.

20. A method of handling a piece good, comprising:
feeding of piece goods on a feed conveyor device comprising a cascade conveyor;
wherein the piece goods are fed such that at least one 2D stream is generated from a 3D stream.
